(19) United States
(12) Patent Application Publication
(10) Pub. No.: US 2011/0250767 A1
(43) Pub. Date: Oct. 13, 2011

(54) ELECTRICAL CONNECTOR SYSTEM HAVING TRANSITION ASSEMBLY

(76) Inventor: Alan Crighton, Apex, NC (US)

(21) Appl. No.: 13/041,723

(22) Filed: Mar. 7, 2011

Related U.S. Application Data
(60) Provisional application No. 61/321,980, filed on Apr. 8, 2010.

(51) Int. Cl. H01R 12/51; H01R 43/20; G09B 19/00

(52) U.S. Cl. 439/65; 434/224; 29/876

(57) ABSTRACT

An electrical connector assembly includes a first substrate and a second substrate that is configured to be placed into and out of electrical communication with the first substrate by moving the second substrate along a direction that is parallel to the first substrate.

### CROSS-REFERENCE TO RELATED APPLICATIONS

This claims the benefit of U.S. Provisional Patent Application Ser. No. 61/321,980, filed Apr. 8, 2010, the disclosure of which is hereby incorporated by reference as if set forth in its entirety herein.

### FIELD OF THE DISCLOSURE

The present disclosure relates generally to electrical connectors, and in particular relates to the connection of a daughtercard to a motherboard.

### BACKGROUND

An electrical system, such as a computer, for example, may include components mounted on printed circuit boards, such as daughtercards, backplane boards, motherboards, and the like, that are interconnected to transfer power and data signals throughout the system. Conventional electrical connector assemblies can include a respective electrical backplane connector attached to each of the motherboard and the daughtercard, for example. The backplane connectors may be joined to one another to electrically connect the motherboard and the daughtercard.

In conventional electrical connector assemblies, the daughtercard may be inserted and removed from a motherboard in an orientation that is substantially perpendicular, coplanar, or parallel to the motherboard. In substantially perpendicular arrangements, the daughtercard is inserted in a direction substantially perpendicular to the motherboard and toward the motherboard until the respective backplane connectors mate, thereby electrically connecting the daughtercard and the motherboard. When the daughtercard is to be electrically disconnected from the motherboard, the daughtercard is removed along a direction substantially perpendicular to the motherboard and away from the mother board so that the backplane connectors become disengaged.

When the motherboard is disposed in a chassis in a horizontal orientation, substantially perpendicular daughtercards are connected to, and disconnected from, the motherboard in a vertical direction. Accordingly, in such applications, the region above the daughtercard is devoid of electrical components in order to provide adequate vertical clearance to accommodate the insertion and removal of daughtercards from the electronic system. Such arrangements present difficulties in systems that have limited availability of vertical space inside the chassis.

What is therefore desired is an electrical connector assembly that overcomes disadvantages associated with conventional electrical connector assemblies.

### SUMMARY

In accordance with one embodiment, an electrical connector assembly includes a first electrical connector, a second electrical connector, and a third electrical connector. The first electrical connector includes a connector housing and a plurality of electrical contacts. The second electrical connector includes a connector housing and a plurality of electrical contacts. The second electrical connector is shaped differently than the first connector but physically mates with the first connector such that the electrical contacts of the second electrical connector are in electrical communication with the electrical contacts of the first electrical connector. The third electrical connector is shaped differently than at least one of the first electrical connector and the second electrical connector and is electrically connected to the second electrical connector by a flex cable.

### BRIEF DESCRIPTION OF THE DRAWINGS

The foregoing summary, as well as the following detailed description of an example embodiment of the application, will be better understood when read in conjunction with the appended drawings. For the purposes of illustrating the present disclosure, there is shown in the drawings an example embodiment. It should be understood, however, that the application is not limited to the precise arrangements and instrumentalities shown. In the drawings:

FIG. 1A is a schematic perspective view of an electrical connector system constructed in accordance with one embodiment, including a first substrate, a second substrate, a transition assembly that is configured to electrically connect the first substrate to the second substrate;

FIG. 1B is another schematic perspective view of the electrical connector system illustrated in FIG. 1A;

FIG. 1C is a perspective view of the electrical connector system with portions removed;

FIG. 2A is a perspective view of a transition module of the transition assembly illustrated in FIG. 1A;

FIG. 2B is a perspective view of a portion of the transition module illustrated in FIG. 2A;

FIG. 2C is another perspective view of a portion of the transition module illustrated in FIG. 2A;

FIG. 2D is another perspective view of a portion of the transition module illustrated in FIG. 2A;

FIG. 2E is a perspective view of a portion of a transition housing of the transition module illustrated in FIG. 2A;

FIG. 3 is a perspective view of a guidance module of the transition assembly illustrated in FIG. 1A;

FIG. 4 is an assembly view of the electrical connector system illustrated in FIG. 1A;

FIG. 5 is a perspective view of the electrical connector system illustrated in FIG. 1A and a chassis configured to support the electrical connector system;

FIG. 6A is a perspective view of first and second electrical connectors of the electrical connector system illustrated in FIG. 1A;

FIG. 6B is a sectional end elevation view of one of the contacts of the first electrical connector illustrated in FIG. 6A;

FIG. 7A is a perspective view of third and fourth electrical connectors of the electrical connector system illustrated in FIG. 1A;

FIG. 7B is a sectional end elevation view of one of the electrical contacts of the third electrical connector illustrated in FIG. 7A; and

FIG. 8 is a perspective view of an auxiliary electrical connector of the electrical connector system illustrated in FIG. 1A.

### DETAILED DESCRIPTION

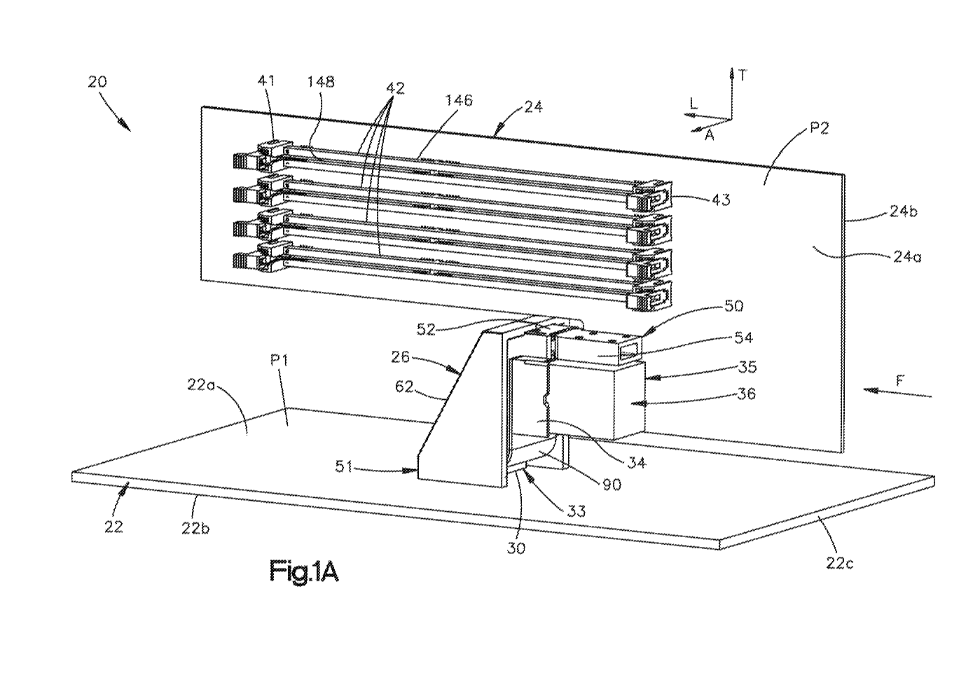

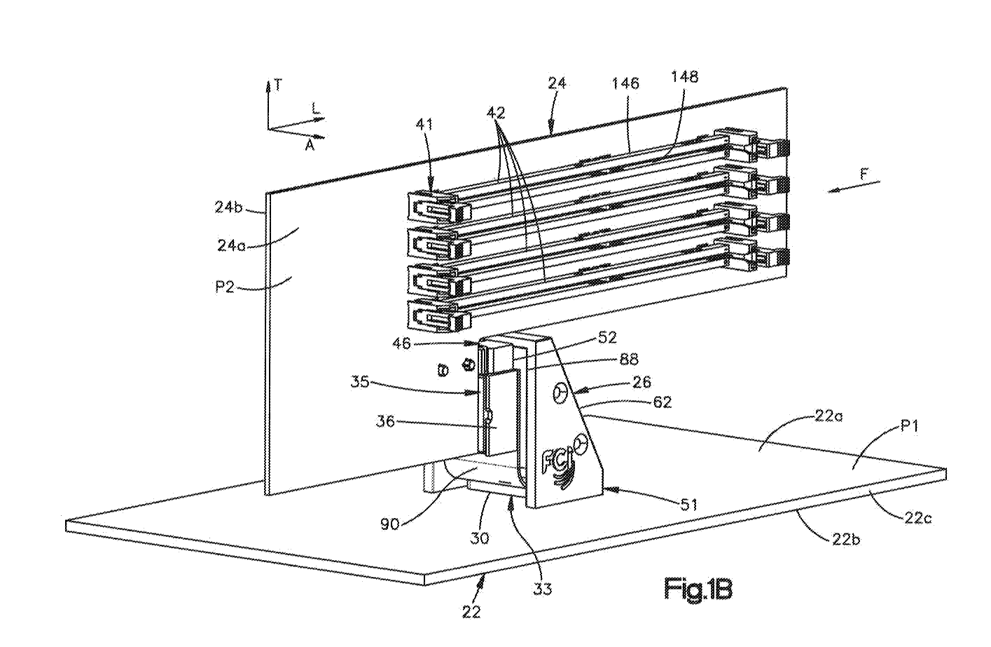

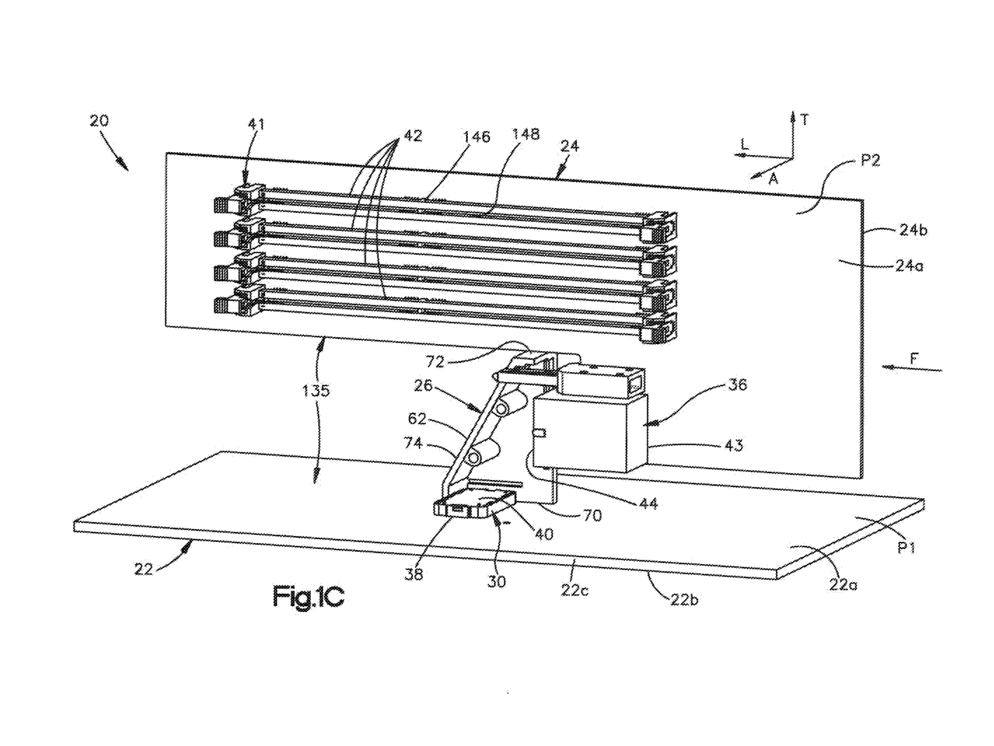

Referring to FIGS. 1A-C, an electrical connector system 20 includes a first substrate 22 that can be provided as a printed circuit board, a second substrate 24 that can be provided as a printed circuit board, a transition assembly 26 configured to electrically connect the first and second substrates 22 and 24, and an auxiliary connector system 41 that can include at least one or more auxiliary electrical connectors 42 that are configured to connect an electrical component to the second substrate 24. For instance, the first substrate 22 can be a main circuit board or motherboard, the second substrate 24 can be a daughtercard, and auxiliary the electrical connectors 42 can each be configured to electrically connect an auxiliary substrate 25 such as a memory card to the daughtercard.

The electrical connector system 20 can further include a first electrical connector assembly 33 that is configured to electrically connect the first substrate 22 with the transition assembly 26. The first electrical connector assembly 33 can include a first electrical connector 30 which can be configured to be mounted to the first substrate 22, and a second electrical connector 32 of the transition assembly 26 that is configured to mate with the first electrical connector 30. It should thus be appreciated that the first electrical connector 30 can be referred to as a first substrate electrical connector, and the second electrical connector 32 can be referred to as a first transition electrical connector of the transition assembly 26.

The electrical connector system 20 can further include a second electrical connector assembly 35 that is configured to electrically connect the second substrate 24 with the transition assembly 26. The second electrical connector assembly 35 can include a third electrical connector 34 configured to be mounted to the second substrate 24, and a fourth electrical connector 36 of the transition assembly 26 that is configured to mate with the third electrical connector 34. It should thus be appreciated that the third electrical connector 34 can be referred to as a second transition electrical connector of the transition assembly 26, and the fourth electrical connector 36 can be referred to as a second substrate electrical connector. Furthermore, the third and fourth electrical connectors 34 and 36 of the electrical connector system 20 can be referred to as first and second electrical connectors, respectively, of the electrical connector assembly 35.

Accordingly, when the first and second electrical connectors 30 and 32 of the first electrical connector assembly 33 are mated, and the third and fourth electrical connectors 34 and 36 of the second electrical connector assembly 35, the first substrate 22 can be placed in electrical communication with the second substrate 24. Each of the auxiliary electrical connectors 42 can be mounted to the second substrate 24, and can be further configured to electrically connect to a respective auxiliary substrate 25, such as a memory card, so as to electrically connect the auxiliary substrate 25 to the second substrate 24, and thus also to electrically connect the auxiliary substrate 25 to the first substrate 22.

The electrical connector system 20 is illustrated as extending horizontally along a longitudinal direction L and a lateral direction A that is substantially perpendicular to the longitudinal direction L, and vertically along a transverse direction T that is substantially perpendicular to the longitudinal and lateral directions L and A, respectively. Thus, as illustrated, the longitudinal direction L and the lateral direction A extend horizontally as illustrated, and the transverse direction T extends vertically, though it should be appreciated that these directions may change depending, for instance, on the orientation of the electrical connector system 20 during use. Unless otherwise specified herein, the terms “lateral,” “longitudinal,” and “transverse” as used to describe the substantially perpendicular directional components of various components and do not limit to specific differential signal pair configurations. The terms “inboard” and “inner,” and “outboard” and “outer” with respect to a specified directional component are used herein with respect to a given apparatus to refer to directions along the directional component toward and away from the center apparatus, respectively. The second substrate 24 can be mated with the first substrate by translating the second substrate 24, and thus the third electrical connector/36 along a longitudinally forward insertion direction F which is parallel to the first substrate 22, so as to mate the third electrical connector 34 with the fourth electrical connector 36.

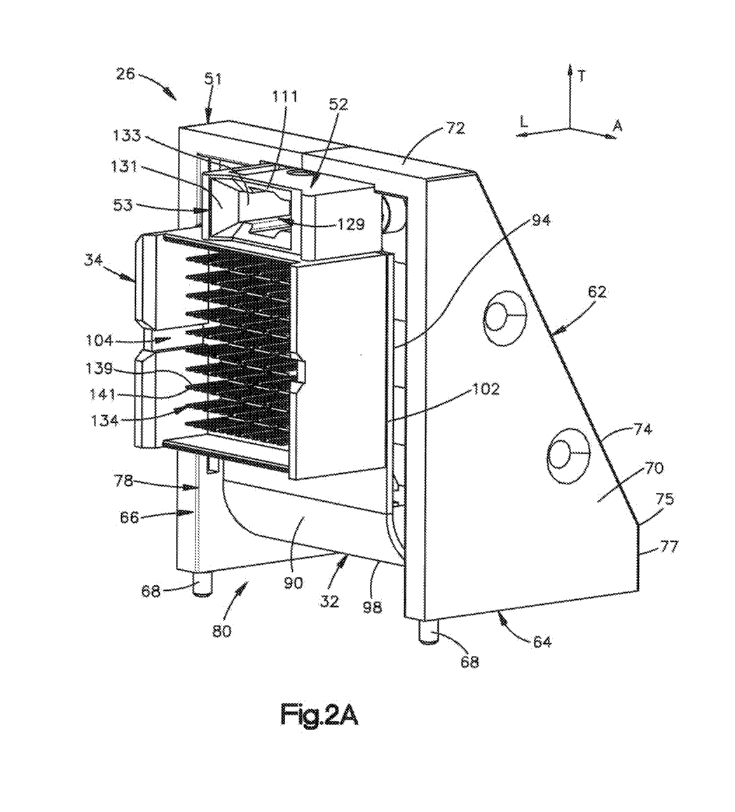

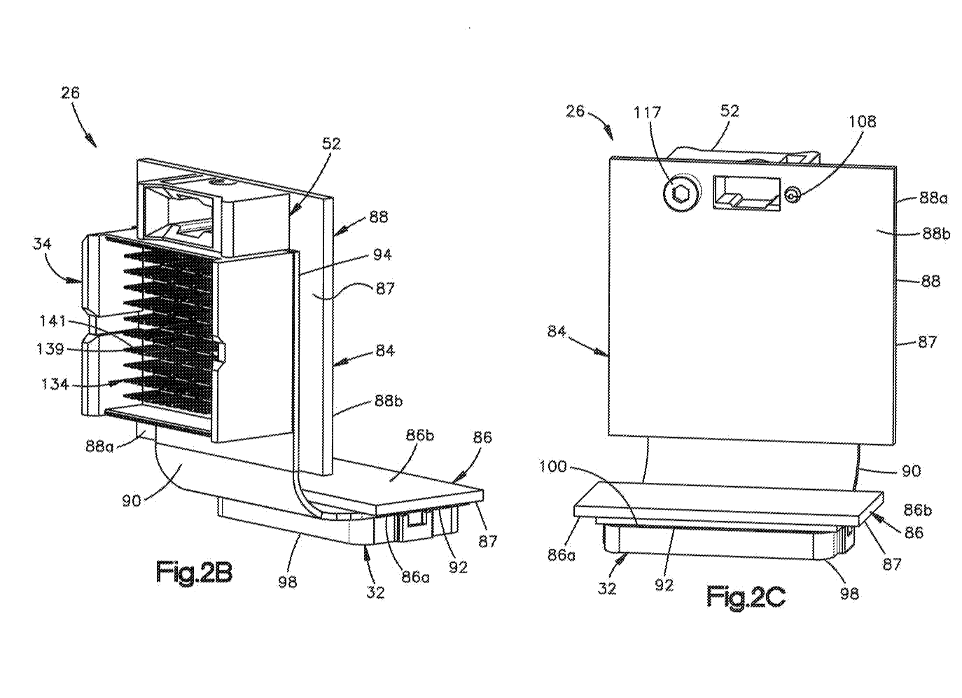

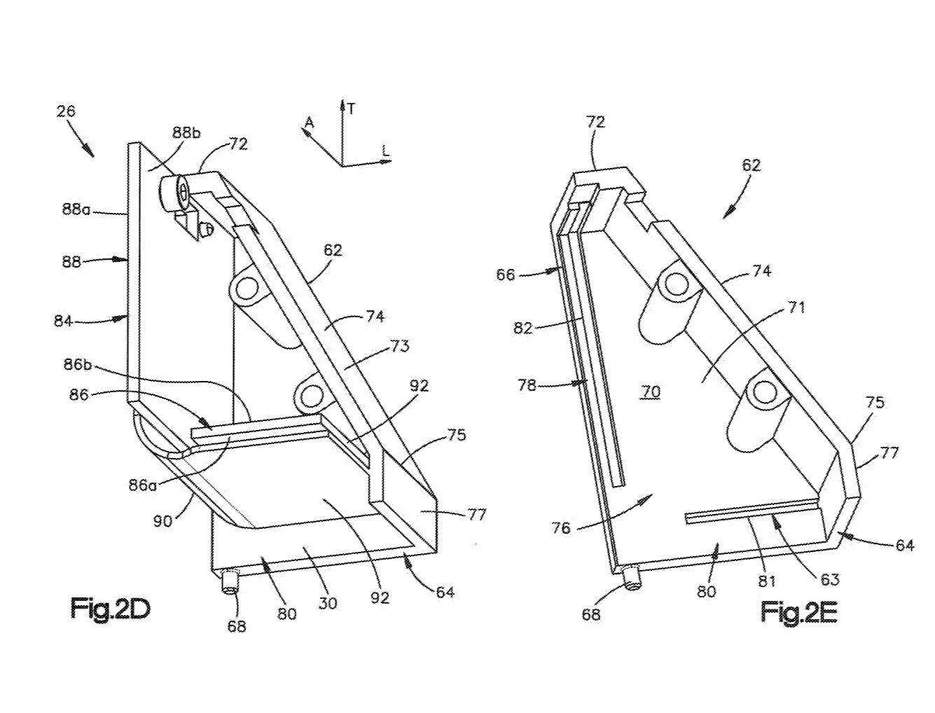

Referring also to FIGS. 2A-E, the transition assembly 26 includes a transition module 51 and a guidance module 52. For instance, the transition module 51 can include a transition housing 62, a pair of electrical connectors, such as the second and third electrical connectors 32 and 34, supported by the transition housing 62, a flex cable 90 that is electrically connected between the second and third electrical connectors 32 and 34 so as to place the second and third electrical connectors 32 and 34 in electrical communication with each other. It should be appreciated that the third electrical connector 34 can be shaped differently than either or both of the first electrical connector 30 and the second electrical connector 32, and is electrically connected to the second electrical connector 32 by the flex cable 90.

The transition module 51 further includes at least one support member illustrated as a pair of support members 84 that are supported by the transition housing. For instance, the pair of support members 84 can be configured as a first support substrate 86 which can be referred to as a first transition substrate, and a second support substrate 88 which can be referred to as a second transition substrate. The first support substrate 86 can be elongate in a plane that is oriented horizontally, and substantially parallel to the first substrate 22 and substantially perpendicular to the second substrate 24. The second support substrate 88 can be elongate in a plane that is oriented vertically, or substantially perpendicular to both the first and second substrates 22 and 24.

Each support substrate 86 and 88 defines an outer surface 87 that faces the corresponding second and third electrical connectors 32 and 34. The outer surface 87 supports a flex cable 90 that generally includes a plurality of conductors or tracks, spaced roughly parallel to each other and embedded in an insulating material. The flex cable 90 includes respective first and second opposing ends 92 and 94 that are attached to the support substrates 86 and 88, respectively. The first end 92 of the flex cable 90 is electrically connected to the electrical contacts of the second electrical connector 32, and the second end 94 of the flex cable 90 is electrically connected to the electrical contacts of the third electrical connector 34. In this regard, the flex cable 90 provides an electrical path 96 that electrically connects the second and third electrical connectors 32 and 34.

Referring again to FIGS. 1A-C, the first substrate 22 defines a first surface 22a or upper surface, an opposed second surface 22b or lower surface, and an outer perimeter 22c. The first substrate 22 is illustrated as oriented or elongate in a respective plane that can be referred to as a first plane P1 and can be elongate along the longitudinal direction L. For instance, the first plane P1 can be a horizontal plane. Accordingly, one or both of the first surface 22a and the second surface 22b can extend along a horizontal plane, and the first electrical connector 30 is mounted onto the first surface 22a of the first substrate 22. As illustrated, the first electrical connector 30 is a mezzanine or vertical connector, though it should be appreciated that the first electrical connector 30 could alternatively be provided in any shape or form as desired, such as a right-angle connector, so as to place electrical contacts of the first electrical connector 30 in electrical communication with electrical traces of the first substrate 22.

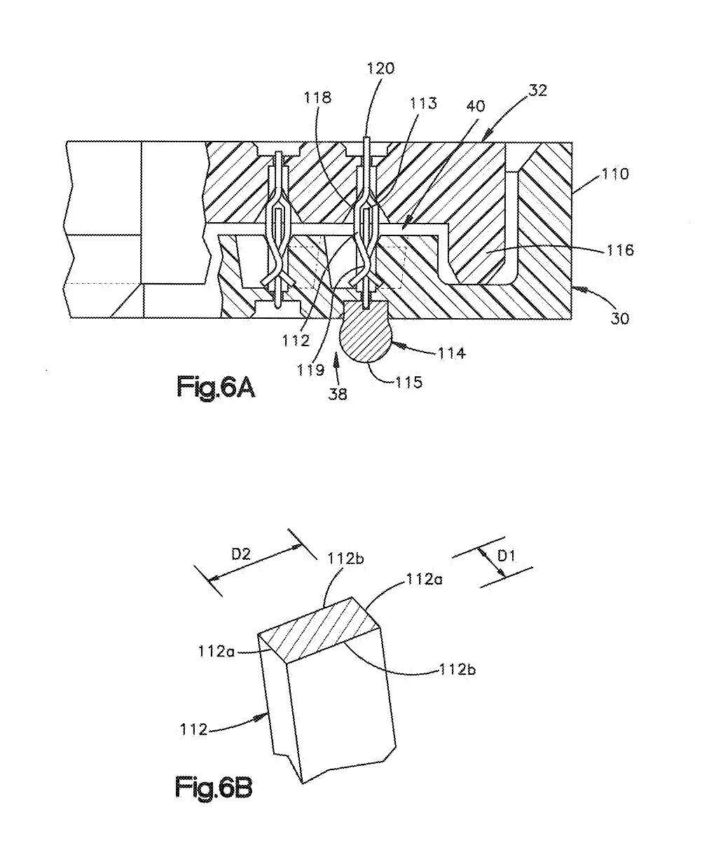

Thus, referring also to FIGS. 6A-B, the first electrical connector 30 includes a mounting portion 38 that is mounted onto the first surface 22a of the substrate, and an opposed mating portion 40 that is configured to mate with the second electrical connector 32, such that at least one or both of the first and second electrical connectors 30 and 32 do not overhang or extend beyond outer perimeter 22c of the first substrate 22. At least one or both of the first and second electrical connector housings 110 and 116 are inwardly recessed with respect to the outer perimeter 22c. The first electrical connector 30 can include a plurality of electrical contacts 112 that define edges 112a, and broadsides 112b, and substrate mount ends 114 that are configured to be electrically connected to the electrical traces on the substrate 22.

With continuing reference to FIGS. 1A-C and 6A-B, the second electrical connector 32, which can also be referred to as a first transition electrical connector of the transition assembly 26 as described above, is illustrated as a mezzanine or vertical connector including a mounting portion 98 configured to mount onto the support substrate 86, and a mating portion 100 configured to mate with the mating portion 40 of the first electrical connector 30, thereby placing the electrical contacts of the second electrical connector 32 in electrical communication with the electrical traces of the first substrate 22. In accordance with one embodiment the second electrical connector 32 is shaped differently than the first electrical connector 30 but physically mates with the first electrical connector 30.

The transition assembly 26 is electrically connected to the first substrate 22 by mating the second electrical connector 32 with the first electrical connector 30 when the first electrical connector 30 is mounted to the first substrate 22. It should be appreciated that the while the first electrical connector 30 is a mezzanine or vertical connector in accordance with the illustrated embodiment, the first electrical connector 30 could alternatively be provided in any shape or form as desired, such as a right-angle connector, so as to establish an electrical path between the flex cable 90 and the second electrical connector 32.

With continuing reference to FIGS. 1A-C, the second substrate 24 defines a first surface 24a or inner surface, an opposed second surface 24b or outer surface, and an outer perimeter 24c. The second substrate 24 is illustrated as oriented or elongate in a respective plane that can be referred to as a second plane P2 that is different than the first plane P1. For instance, the second plane P2 is angularly offset, for instance substantially perpendicular, with respect to the first plane P1 of the first substrate 22. For instance, the second plane P2 can be a vertical plane. Accordingly, one or both of the first surface 24a and the second surface 24b can extend along a horizontal plane. The second substrate 24 and can be elongate along the longitudinal direction L. The fourth electrical connector 36 can be mounted onto the first surface 24a of the second substrate 24. As illustrated, the fourth electrical connector 36 is a right-angle electrical connector, though it should be appreciated that the fourth electrical connector 36 could alternatively be provided in any shape or form as desired, such as a vertical or mezzanine connector, so as to place electrical contacts of the fourth electrical connector 36 in electrical communication with electrical traces of the second substrate 24.

Thus, referring to FIGS. 1A-C and 7A-B, the fourth electrical connector 36 includes a mounting portion 43 that is mounted onto the first surface 24a of the substrate 24, and an opposed mating portion 44 that is oriented substantially perpendicular to the mounting portion 43. In accordance with one embodiment, the fourth electrical connector 36 does not extend beyond or overhang the outer perimeter 22c of the first substrate 22 when the third and fourth electrical connectors 34 and 36 are mated. The second substrate 24 can define a cut-out 46 extending up into a portion of the bottom of the substrate. The cut-out 46 extends upward a distance sufficient to provide clearance for the transition assembly 26. The mating portion 44 is disposed in the cut-out 46, and is configured to mate with the third electrical connector 34 such that the second substrate 24 is suspended above the first substrate 22.

The fourth electrical connector 36 includes a plurality of electrical contacts 124 that define edges 124a, broadsides 124b, and substrate mount ends 126 that are configured to be electrically connected to the electrical traces on the second substrate 24. The edges 124a have a cross-sectional dimension less than that of the broadsides 124b. Thus, the broadsides 124b are longer than the edges 124a. The broadsides 124b of the electrical contacts 124 of the fourth electrical connector 36 extend along a first or horizontal plane, and thus substantially parallel to the plane P1 of the first substrate 22, while the edges of the electrical contacts of the fourth electrical connector 36 extend along a second or vertical plane, substantially planar to the plane P2 of the second substrate 24. Thus, at least one up to all of the electrical contacts 124 of the fourth electrical connector 36 are oriented such that the edge 124a of at least one up to all of the electrical contacts 124 are oriented to face the second substrate 24 and thus the second plane P2 of the second substrate, and the broadsides 124b of at least one up to all electrical contacts 124 is oriented to face the first substrate 22 and thus the first plane P1 of the first substrate 22.

Furthermore, the broadsides 124b of the electrical contacts 124 of the fourth electrical connector 36 can be oriented substantially perpendicular to the broadsides 112b of the electrical contacts 112 of the first electrical connector 30. Likewise, the edges 124a of the electrical contacts 124 of the fourth electrical connector 36 can be oriented substantially perpendicular to the edges 112a of the electrical contacts 112 of the first electrical connector 30. In accordance with the illustrated embodiment, the electrical contacts 124 of the fourth electrical connector 36 are not physically connected to the first substrate 22. Likewise, the electrical contacts 112 of the first electrical connector 30 are not physically connected to the second substrate 24.

The third electrical connector 34 is illustrated as a mezzanine or vertical connector including a mounting portion 102 configured to mount onto the support substrate 88, and a mating portion 104 configured to mate with the mating portion 44 of the fourth electrical connector 36, thereby placing the electrical contacts 134 of the third electrical connector 34 in electrical communication with the electrical traces of the second substrate 24. It should be appreciated that the while the third electrical connector 34 is a mezzanine or vertical connector in accordance with the illustrated embodiment, the third electrical connector 34 could alternatively be provided in any shape or form as desired, such as a right-angle connector, so as to establish an electrical path between the flex cable 90 and the third electrical connector 34. The third electrical connector 34 can be shaped differently than at least one of or both of the first and second electrical connectors 30 and 32.

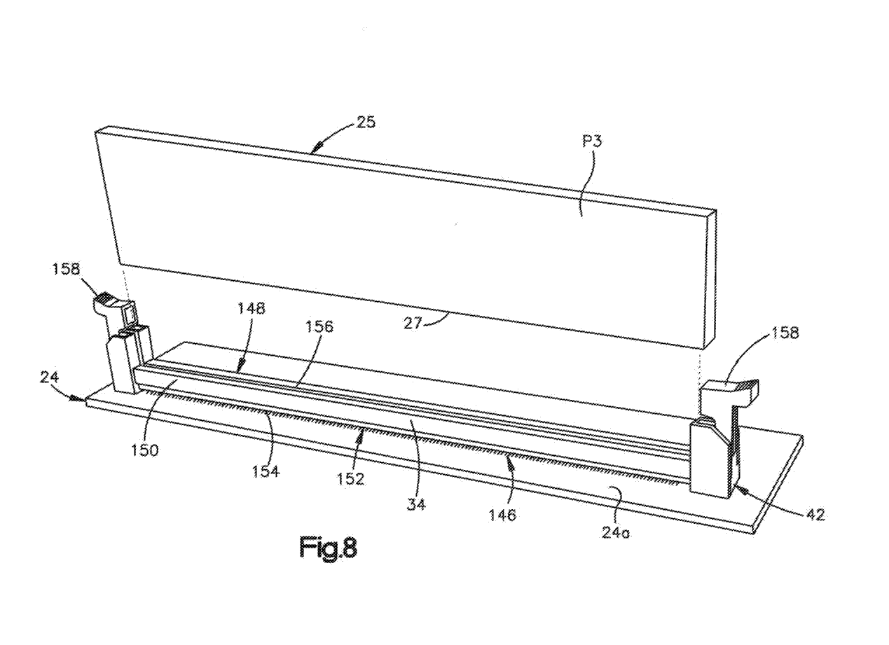

Referring now to FIGS. 1A-C and FIG. 8, the electrical connector system 20 can further include at least one or more auxiliary electrical connectors 42 that can be mounted onto either surface 24a or 24b of the second substrate 24, and can each be configured to electrically connect a respective auxiliary substrate 25, which can be provided as a memory card, to the second substrate 24, and thus to the first substrate 22 via the transition assembly 26 in the manner described above. For instance, the auxiliary electrical connectors 42 can include a mounting portion 146 that is mounted onto the substrate 24, and an opposed mating portion 148 that is oriented substantially perpendicular to the mounting portion 146 and configured to mate with the auxiliary substrate 25 such that the auxiliary substrates 25 that are oriented or elongate along a third plane P3 that extends substantially perpendicular to the second substrate 24, and substantially parallel to the first substrate 22. As illustrated, the auxiliary electrical connectors 42 can be mounted onto the second substrate 24 at positions vertically spaced from each other. In accordance with the illustrated embodiment, the auxiliary electrical connectors 42 mounted onto the surface 24a are aligned with the connectors mounted onto the second surface 24b. The auxiliary electrical connectors 42 can be constructed in any suitable manner as desired, for instance as described below with reference to FIG. 8.

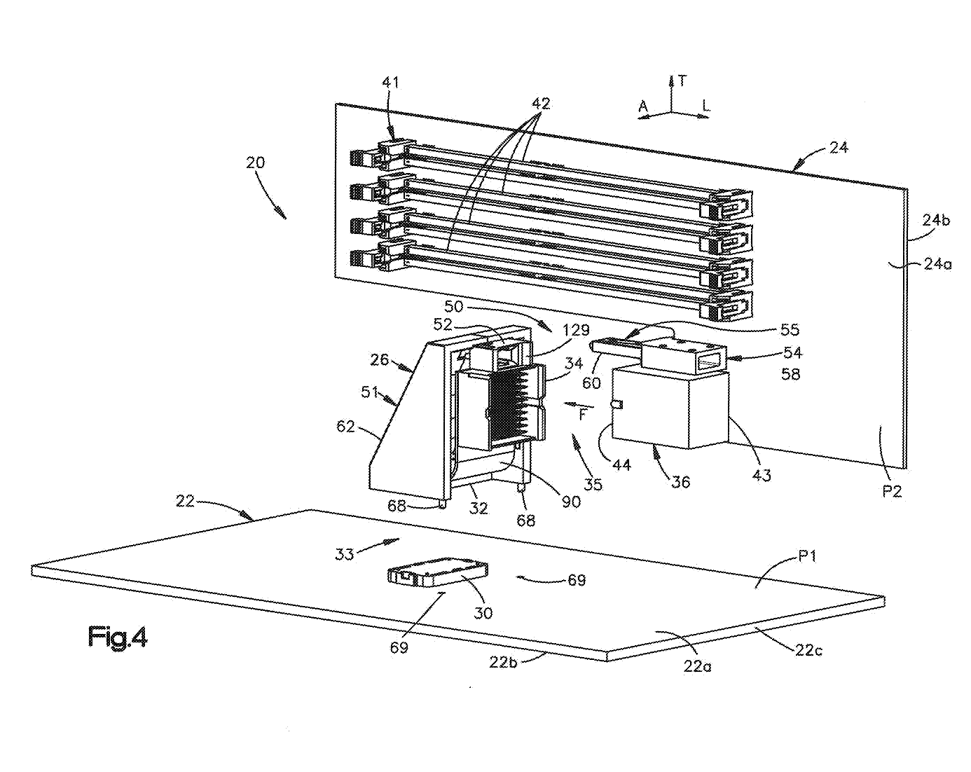

Referring now to FIGS. 2A-2E, the transition assembly 26 includes a transition housing 62 and the second and third electrical connectors 32 and 34 that are supported by the transition housing 62. The transition assembly 26 thus provides an interface configured to establish an electrical connection between the first electrical connector 30 and the fourth electrical connector 36. The transition housing 62 defines a first mounting end 64 which can be oriented horizontally and configured to be mounted onto the first substrate 22 such that the second electrical connector 32 mates with the first electrical connector 30, and a second mounting end 66 that is configured to interface with the fourth electrical connector 36 so as to electrically connect the third electrical connector 34 to the second substrate 24. The mounting end 64 includes a plurality of downwardly projecting mounting pegs 68 that are configured to be press-fit into apertures 69 (see FIG. 4) extending into the first surface 22a of the first substrate 22 or otherwise mounted onto the first surface 22a so as to secure the transition housing 62 to the first substrate 22. The mounting pegs 68 can thus align the second electrical connector 32 with the first electrical connector 30, and can further provide mechanical support for the transition assembly 26 when the first and second electrical connectors 30 and 32 are mated.

The transition housing 62 defines a pair of spaced side walls 70, a top wall 72 connected between the side walls 70, for instance between upper ends of the side walls 70, a sloped front wall 74 that extends out from the top wall 72 toward the bottom ends of the side walls 70. The mounting pegs 68 project down from the bottom surface of the side walls 70. In accordance with the illustrated embodiment, the side walls 70 are laterally spaced, the top wall 72 extends substantially horizontally, and the front wall 74 is sloped longitudinally forward as it travels down from the top wall 72 toward the bottom ends of the side walls 70. The front wall 74 can define an angled elbow 75 and a lower 77 end that is oriented substantially vertically and disposed below the elbow 75. It should be appreciated that transition housing 62 thus defines an internal void 76 having an open base 78 and an open longitudinal rear end 80. The internal void 76 can be at least partially defined by the side walls 70, the top wall 72, and the front wall 74.

The transition housing 62 defines an inner surface 71 that faces the void 76, and an opposed outer surface 73 that faces away from the void 76. The transition housing 62 defines a retention assembly 63 that is configured to support, either directly or indirectly, the second and third electrical connectors 32 and 34. For instance, in accordance with the illustrated embodiment, the transition housing 62 defines a first retention slot 81 that extends into the inner surfaces 71 of the opposed side walls 70 at a location proximate to the first mounting end 64. The first retention slot 81 is horizontally elongate along a direction substantially parallel to the first substrate 22 when the transition housing 62 is mounted onto the first substrate 22. The first retention slot 81 can extend laterally into but not through the side walls 70, or can alternatively extend through the side walls 70. The first retention slots 81 can have a thickness substantially equal to the thickness of the first support substrate 86. The transition housing 62 further includes a second retention slot 82 that extends into the inner surfaces 71 of the opposing side walls 70 at a location proximate to the second mounting end 66. The second retention slot 82 is vertically elongate, and thus can be elongate along a direction substantially parallel to the second substrate 24. The second retention slot 82 can extend laterally into but not through the side walls 70, or can alternatively extend through the side walls 70. The second retention slots 82 can have a thickness substantially equal to the thickness of the second support substrate 88.

The first support substrate 86 has a thickness and extends laterally a distance sufficient so as to fit in the opposing pair of retention slots 81, so that the first support substrate 86 is oriented horizontally, or parallel to the first substrate 22. The first support substrate 86 defines a first outer surface 86a that faces out from the transition housing 62, and a second opposed inner surface 86b that faces the internal void 76 of the transition housing 62. The second support substrate 88 has a thickness and extends laterally a distance sufficient so as to fit in the opposing pair of retention slots 82, so that the second support substrate 88 is oriented vertically and substantially perpendicular the first substrate 22 and parallel to the mating portion 44 of the fourth electrical connector 36. The second support substrate 88 defines a first outer surface 88a that faces out from the transition housing 62, and a second opposed inner surface 88b that faces the internal void 76 of the transition housing 62.

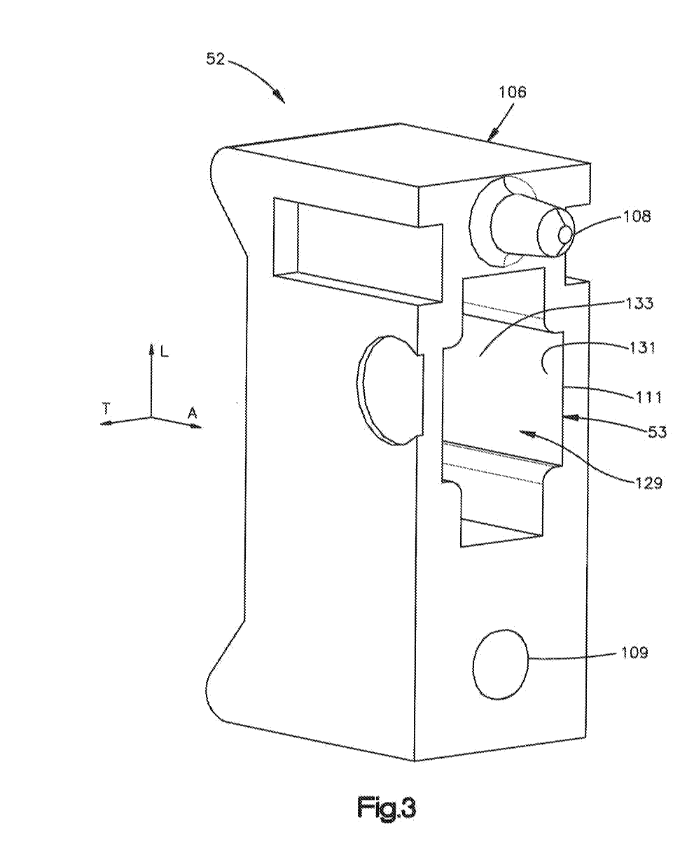

Referring to FIGS. 3-4, the electrical connector system 20 includes a guidance assembly 50 that is configured to align the third electrical connector 34 with the fourth electrical connector 36 such that movement of the fourth electrical connector 36 relative to the third electrical connector 34 along the insertion direction F causes the third and fourth electrical connectors 34 and 36 to mate. The guidance assembly 50 includes a first guidance module 52 of the transition assembly 26 that is fixed with respect to the third electrical connector 34, and a second guidance module 54 that is fixed with respect to the fourth electrical connector 36. The first and second guidance modules 52 and 54 are configured to engage to each other when the third and fourth electrical connectors 34 and 36 are aligned to mate before the third and fourth electrical connectors 34 and 36 are mated.

The transition assembly 26 includes the first guidance module 52, which includes a guidance housing 106 having a mount which can be configured as a mounting peg 108 and a mounting aperture 109 as illustrated that are configured to be press-fit into a complementary aperture that extends through the second support substrate 88 and receive a fastener 117 (see FIG. 2C), respectively, so as to mount the guidance housing 106 to the substrate 88 at a fixed location with respect to the third electrical connector 34, for instance adjacent the third electrical connector 34. In accordance with the illustrated embodiment, the guidance housing 106 can be positioned immediately adjacent the third electrical connector 34. The first guidance module 52 includes an engagement member 53 that is configured to engage a complementary engagement member 55 of the second guidance module 54, which can be configured as a guidance post 60, so as to attach the first and second guidance modules 52 and 54.

In accordance with the illustrated embodiment illustrated in FIG. 2A, the engagement member 53 is configured as a guidance aperture 129 that extends through the guidance housing 106 and is configured to receive the guidance post 60 of the second guidance module 54. The guidance aperture 129 can be constructed as desired, and in the illustrated embodiment defines a mouth 131 that can be bevelled, and thus wider than the guidance post 60, and a channel 133 that is disposed longitudinally rearward with respect to the mouth 131, and is sized substantially the same as the guidance post 60. Thus, the mouth 131 can neck down to the channel 133 as it travels rearwards. Alternatively, as illustrated in FIG. 3, the mouth 131 can be sized substantially equal to the channel 133. In accordance with the illustrated embodiment, the guidance aperture 129 can be keyed so as to engage the guidance post 60 in a predetermined orientation. In accordance with the illustrated embodiment, the guidance aperture 129 can define a keying feature, such as a recess 111, that is configured to receive the guidance post 60 in a predetermined orientation, and configured to prevent the channel 133 from receiving the guidance post 60 when the guidance post 60 is not in the predetermined orientation. Accordingly, when the guidance post 60 is in the predetermined orientation, the guidance aperture 129 can initially receive the guidance post 60 when the third and fourth electrical connectors 34 and 36 are loosely aligned and the second substrate 24 and the fourth electrical connector 36 is moved along the insertion direction F so as to mate the third and fourth electrical connectors 34 and 36.

With continuing reference to FIG. 4, the second guidance module 54 includes a guidance housing 58 having a mount which can be mounted to the first surface 24a of the second substrate 24 at a fixed location with respect to the fourth electrical connector 36, for instance adjacent the fourth electrical connector 36. In accordance with the illustrated embodiment, the guidance housing 58 can be positioned immediately adjacent the fourth electrical connector 36. The first guidance second guidance module 54 includes an engagement member 55 that is configured to engage the complementary engagement member 55 of the second guidance module 54 so as to align the third and fourth electrical connectors 34 and 36, such that movement of the fourth electrical connector 36 along the insertion direction F causes the third and fourth electrical connectors 34 and 36 to mate.

As described above, the guidance member 55 can be configured as a guidance post 60 that extends longitudinally out, or rearward, from the guidance module body 58. The guidance post 60 extends past the mating portion 44 of the fourth electrical connector 36 a sufficient distance such that the guidance post 60 can be received in the guidance aperture 129 before the third and fourth electrical connectors 34 and 36 are mated. In accordance with the illustrated embodiment, guidance post 60 extends past the mating portion 44 of the fourth electrical connector 36 a sufficient distance such that the guidance post 60 is received in the channel 133 before the third and fourth electrical connectors 34 and 36 are mated. It should be appreciated that the guidance assembly 50 can be constructed in accordance with any alternative embodiment as desired. For instance, the engagement member 55 can alternatively be configured as a guidance aperture that can be constructed as described above with respect to the guidance aperture 129, while the engagement member 53 can be configured as a guidance post that can be configured as the guidance post 60 as described above.

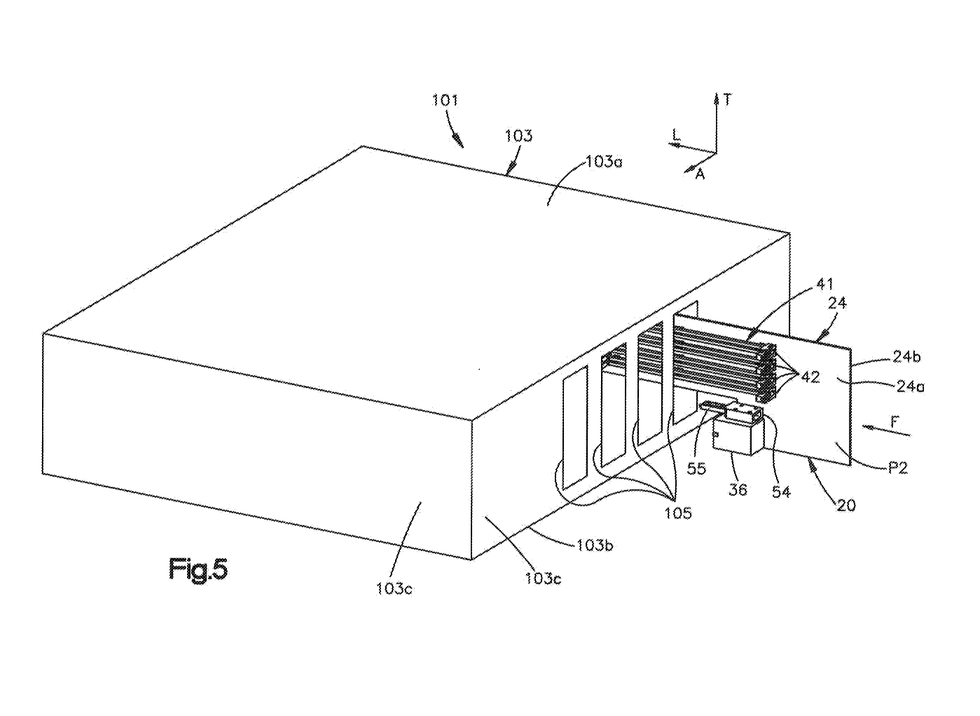

Referring to FIGS. 4-5, it should be appreciated that the second substrate 24 is inserted along the longitudinal insertion direction F, which is parallel to first surface 22a of the first substrate 22, in order to mate the fourth electrical connector 36 with the third electrical connector 34, thereby bringing the respective electrical contacts 124 and 134 in electrical communication with each other. Accordingly, when the transition assembly 26 is mounted to the first substrate 22, such that the first and second electrical connectors 30 and 32 are mated, mating the third and fourth electrical connectors 34 and 36 places the first and second substrates 22 and 24 in electrical communication with each other. Likewise, when it is desired to electrically disconnect the second substrate 24 from electrical communication with the first substrate 22, the second substrate 24 and the fourth electrical connector 36 are removed along the longitudinal direction L opposite the insertion direction F, which is parallel to the first surface 22a of the first substrate 22.

Thus, an electrical system 101 can include a chassis 103 and the electrical connector system 20 configured to be supported by the chassis 103. The chassis 103 can define an upper wall 103a, a lower wall 103b, and at least one side wall 103c such as a plurality of side walls 103c that extend between the upper and lower walls 103a and 103b. For instance, the first substrate 22, which can be configured as a motherboard in the manner described above, and the transition assembly 26 can be disposed in the chassis such that the first substrate 22 is oriented horizontally in the chassis 103, substantially parallel to the lower wall 103b, and the first and second electrical connectors 30 and 32 are mated. During operation, at least one or a plurality of select auxiliary substrates 25 (see FIG. 8), which can be configured as memory cards in the manner described above, can be mated with the respective auxiliary electrical connectors 42 so as to place the auxiliary substrates 25 in electrical communication with the second substrate 24.

The second substrate 24, which can be configured as a daughtercard in the manner described above, can be placed in electrical communication with the first substrate 22 by moving the second substrate 24 and thus the corresponding fourth electrical connector 36, through one of a plurality of openings 105 that extends through one of the side walls 103c along the insertion direction F which can be substantially parallel to the lower wall 103b and further substantially parallel to the upper surface 22a of the first substrate 22 until the third and fourth electrical connectors 34 and 36 are mated. The openings 105 can be sized as desired so as to accommodate the second substrate and the memory cards. It should be appreciated that once the third and fourth electrical connectors mate 34 and 36 mate, the auxiliary substrates 25 are placed in electrical communication with the first substrate 22.

In accordance with the illustrated embodiment, the third electrical connector 34 is mounted onto the second support substrate 88 so that the both the third electrical connector 34 and the second substrate 24 are suspended above the first substrate 22 by a gap 135 (see FIG. 1C). When the third and fourth electrical connectors 34 and 36 are mated, an electrical path is thus established between the first substrate 22 and the transition assembly 26, and in particular the second electrical connector 32. The transition assembly 26, and in particular the flex circuit 90, establishes an electrical path between the second electrical connector 32 and the third electrical connector 34. An electrical path further is established between the transition assembly 26 and the second substrate 24 when the third and fourth electrical connectors 34 and 36 are mated. An electrical path is also established between the second substrate 24 and each of the auxiliary substrates 25 when the auxiliary substrates 25 are mated with the auxiliary electrical connectors 42.

When it is desired to disconnect the auxiliary substrates 25 from electrical communication with the first substrate 22, for instance when replacing one or more of the auxiliary substrates 25 with another auxiliary substrate 25, the second substrate 24 can be removed from electrical communication with the first substrate 22 by moving the second substrate 24 and thus the corresponding fourth electrical connector 36 along a second direction opposite the insertion direction F. As the second substrate 24 and the corresponding fourth electrical connector 36 are moved along the second direction, the third and fourth electrical connectors 34 and 36 are disconnected, thereby electrically disconnecting the second and auxiliary substrates 24 and 25 from the transition assembly 26, and thus electrically disconnecting the second and auxiliary substrates 24 and 25 from the first substrate 22. The second substrate 24 and fourth electrical connector 36 can be removed from the third electrical connector 34 substantially along the second direction until they are disposed outside the chassis 103 if desired. One or more of the auxiliary substrates 25 can be removed from the respective auxiliary electrical connectors 42, and one or more other auxiliary substrates 25 can be mated with the auxiliary electrical connectors 42, and the third and fourth electrical connectors 34 and 36 can be again mated inside the chassis 103 in the manner described above. It should be further appreciated that the electrical system 101 can include a plurality of electrical connector systems 20 that can be electrically connected to and from the first substrate 24 through respective openings 105, or to and from other respective substrates 24 in the manner described above.

Accordingly, a method can be provided to replace a daughtercard in an electrical connector assembly 22. The method can include the steps of 1) providing or teaching the use of the first electrical connector 30 that is capable of being attached to the substrate 22 that is oriented in the first plane P1, 2) providing or teaching the use of another electrical connector (e.g., the fourth electrical connector 36) that is capable of being placed in electrical communication with the first electrical connector 30 and is capable of being attached to the second substrate 24 that is oriented in a plane P2 that is substantially perpendicular to the first plane P1, and 3) permitting or teaching movement of the second substrate 24 in a direction parallel to the first substrate 22, such as the first plane P1, when the other electrical connector 36 is placed into or out of electrical communication with the first electrical connector 30.

As described above, the first electrical connector 30, the second electrical connector 32, the third electrical connector 34, the fourth electrical connector 36, and the auxiliary electrical connectors 42 can be constructed having any suitable configuration as desired. Thus, while the electrical connectors are described in more detail below with respect to certain embodiments, it should be appreciated that the electrical connectors can be constructed in accordance with any alternative embodiment such that they are capable of placing respective first and second electrical components in electrical communication with each other.

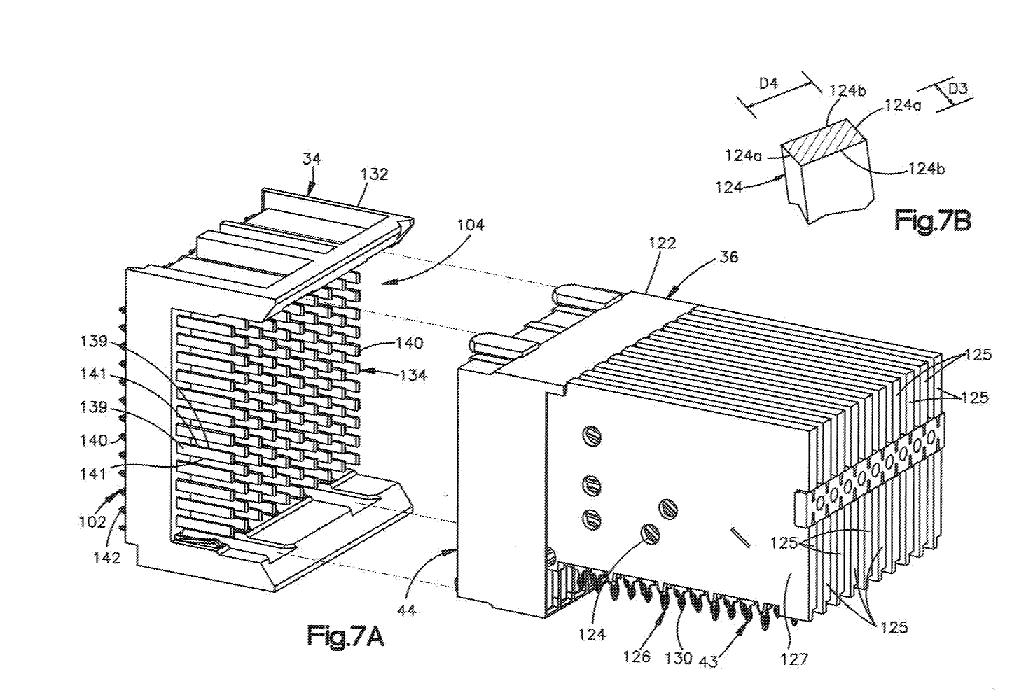

It should thus be appreciated that the electrical connector assembly 20 can include a first electrical connector (e.g., the first electrical connector 30) that has first electrical contacts (e.g., electrical contacts 112), each of the first electrical contacts comprising a first edge 112a, a first broadside 112b, and a first substrate mount end 124 that is configured to be mounted to the first substrate 22 (see FIGS. 6A-B). The electrical connector assembly 20 can further include a second electrical connector (e.g., the third electrical connector 34) that is electrically connected to the first electrical connector 30, the second electrical connector comprising second electrical contacts 124 that each comprise a second edge 124a, a second broadside 124b, and a second substrate mount end 126 (see FIGS. 7A-B). The broadside of one of the first electrical contacts is oriented substantially perpendicular to the second broadside of one of the second electrical contacts, and the second electrical connector does not extend beyond an edge of the first substrate.

Referring to FIGS. 6A-B, the first and second electrical connectors 30 and 32 can be constructed substantially as described in U.S. Pat. No. 6,042,389, the disclosure of which is hereby incorporated by reference as if set forth in its entirety herein. For instance, in accordance with the illustrated embodiment, the first electrical connector 30 can be configured as a plug connector having an insulating or dielectric connector housing 110 that supports a first plurality of electrical contacts 112 that can be configured as plug contacts. The electrical contacts 112 can include a plurality of signal contacts and a plurality of ground contacts disposed adjacent select ones of the signal contacts. For instance, the ground contacts can be disposed adjacent differential signal pairs of the electrical contacts 112.

The first electrical connector 30 defines a mounting portion 38 that is mounted onto the first surface 22a of the substrate as described above, and an opposed mating portion 40 that is configured to mate with the second electrical connector 32. The electrical contacts 112 can define respective opposed edges 112a and opposed broadsides 112b that extend between the opposed edges 112a. In accordance with the illustrated embodiment, the edges 112a and the broadsides 112b extend substantially perpendicular to each other. Furthermore, the edges 112a have a cross-sectional dimension D1 less than the cross-sectional dimension D2 of the broadsides 112b. Thus, the broadsides 112b are longer than the edges 112a. The electrical contacts 112 further define respective substrate mount ends 114 that are configured to be electrically connected to the electrical traces of the first substrate 22 and opposed respective mating ends 113 that are configured to be electrically connected to the second electrical connector 32. In accordance with the illustrated embodiment, the substrate mount ends 114 can include a solder ball 115 that is configured to be surface mounted to corresponding contact pads of the first substrate 22. Alternatively, the substrate mount ends 114 can each include a press-fit tail that is configured to extend into plated holes of the first substrate 22. Accordingly, the first electrical connector 30 can be said to be both electrically and physically connected to the first substrate 22.

The second electrical connector 32 can be configured as a receptacle connector having an insulating or dielectric connector housing 116 that supports a second plurality of electrical contacts 118 that can be configured as receptacle contacts. The electrical contacts 118 can include a plurality of signal contacts and a plurality of ground contacts disposed adjacent select ones of the signal contacts. For instance, the ground contacts can be disposed adjacent differential signal pairs of the electrical contacts 118. The second electrical connector 32 can define a mounting portion 98 that is configured to mount onto the first support substrate 86, and a mating portion 100 that is configured to mate with the mating portion 40 of the first electrical connector 30, thereby placing the electrical contacts 118 of the second electrical connector 32 in electrical communication with the electrical traces of the first substrate 22. For instance, the electrical contacts 118 of the second electrical connector 32 define mating ends 119 that are configured to receive the mating ends 113 of the electrical contacts 112 of the first electrical connector 30 when the first and second electrical connectors 30 and 32 are mated, thereby placing the electrical contacts 112 and 118 in electrical communication with each other. The electrical contacts 118 further define respective mount ends 120 that are configured to be electrically connected to the electrical conductors of the flex cable 90. The electrical contacts 118 can further define respective edges and broadsides that are configured and oriented as described above with respect to the electrical contacts 112.

In accordance with one embodiment the second electrical connector 32 is shaped differently than the first electrical connector 30 but physically mates with the first electrical connector 30. The connector housings 110 and 112 can be configured such that the connector housing 112 of the second electrical connector 32 is received by the connector housing 110 of the first electrical connector 30. Alternatively, the connector housing 110 of the first electrical connector 30 can be received by the connector housing 112 of the second electrical connector 32.

The mounting portion 38 and the mating portion 40 of the first electrical connector 30 are oriented substantially parallel to each other, and the mounting portion 98 and the mating portion 100 of the second electrical connector 32 are likewise oriented substantially parallel to each other. Accordingly, the first and second electrical connectors 30 and 32 can be referred to as vertical or mezzanine connectors. Alternatively, the first and second electrical connectors 30 and 32 can be configured as right-angle electrical connectors, whereby the mounting portion 38 and the mating portion 40 are oriented substantially perpendicular to each other, and the mounting portion 98 and the mating portion 100 are likewise oriented substantially perpendicular to each other. Furthermore, because the electrical contacts 118 receive the electrical contacts 112, the second electrical connector 32 can be referred to as a receptacle connector and the first electrical connector 30 can be referred to as a header connector. Alternatively, the first electrical connector 30 can be configured as a receptacle connector and the second electrical connector 32 can be configured as a header connector, whereby the electrical contacts 112 receive the electrical contacts 118. It should be further appreciated that the first and second electrical connectors 30 and 32 can be constructed in accordance with any suitable alternative embodiment as desired. For instance, the first and second electrical connectors 30 and 32 can be constructed as described in U.S. Pat. No. 6,869,292, the disclosure of which is hereby incorporated by reference as if set forth in its entirety herein.

Referring now to FIGS. 7A-B, the third and fourth electrical connectors 34 and 36 can be constructed as described in U.S. Pat. No. 6,994,569, the disclosure of which is hereby incorporated by reference as if set forth in its entirety herein. It should be appreciated, however, that the third and fourth electrical connectors 34 and 36 can be constructed in accordance with any suitable alternative embodiment as desired. For instance, the third and fourth electrical connectors 34 and 36 can be constructed as described in U.S. Pat. No. 7,497,736 the disclosure of which is hereby incorporated by reference as if set forth in its entirety herein.

In accordance with the illustrated embodiment, the fourth electrical connector 36 can be configured as a right-angle receptacle connector having an insulating or dielectric connector housing 122 that supports a plurality of electrical contacts 124 that can be configured as receptacle contacts. The electrical contacts 124 can include a plurality of signal contacts and a plurality of ground contacts disposed adjacent select ones of the signal contacts. For instance, the ground contacts can be disposed adjacent differential signal pairs of the electrical contacts 124.

The fourth electrical connector 36 can include a plurality of leadframe assemblies 125 that include respective leadframe housings 127 that support the electrical contacts 124. The leadframe housing 127 can be overmolded onto the electrical contacts 124, or can support the electrical contacts 124 in any alternative manner as desired. The fourth electrical connector 36 can define a mounting portion 43 that is configured to be mounted onto the first surface 24a of the second substrate 24 so as to be placed in electrical communication with the electrical traces of the second substrate, and an opposed mating portion 44 that is oriented substantially perpendicular to the mounting portion 43 and configured to mate with the complementary third electrical connector 34. The electrical contacts 124 can define respective opposed edges 124a and opposed broadsides 124b that extend between the opposed edges 124a. In accordance with the illustrated embodiment, the edges 124a and the broadsides 124b extend substantially perpendicular to each other. Furthermore, the edges 124a have a cross-sectional dimension D3 less than the cross-sectional dimension D4 of the broadsides 124b. Thus, the broadsides 124b are longer than the edges 124a. The cross-sectional dimensions D3 and D4 can be greater than, less than, or substantially equal to the cross-sectional dimensions D1 and D2 described above with respect to the first electrical connector 30. The electrical contacts 124 further define respective substrate mount ends 126 that are configured to be electrically connected to the electrical traces of the second substrate 24 and opposed respective mating ends that are configured to be electrically connected to the third electrical connector 34. In accordance with the illustrated embodiment, the substrate mount ends 126 can be provided as press-fit tails 130 that are configured to extend into plated holes of the second substrate 22. Alternatively, the substrate mount ends 126 can include solder balls that are configured to be surface mounted to corresponding contact pads of the first substrate 22. Accordingly, the fourth electrical connector 36 can be said to be both electrically and physically connected to the second substrate 24.

The third electrical connector 34 can be configured as a mezzanine or vertical connector having an insulating or dielectric connector housing 132 that supports a plurality of electrical contacts 134. The electrical contacts 134 can include a plurality of signal contacts and a plurality of ground contacts disposed adjacent select ones of the signal contacts. For instance, the ground contacts can be disposed adjacent differential signal pairs of the electrical contacts 134. The third electrical connector 34 includes a mounting portion 102 configured to mount onto the second support substrate 88, and a mating portion 104 configured to mate with the mating portion 44 of the fourth electrical connector 36, thereby placing the electrical contacts 134 of the third electrical connector 34 in electrical communication with the electrical traces of the second substrate 24. For instance, the electrical contacts 134 of the third electrical connector 34 define mating ends 140 that are configured to be received by the mating ends of the electrical contacts 124 of the fourth electrical connector 36 when the third and fourth electrical connectors 34 and 36 are mated, thereby placing the electrical contacts 134 and 124 in electrical communication with each other. The electrical contacts 134 further define respective mount ends 142 that are configured to be electrically connected to the electrical conductors of the flex cable 90. The electrical contacts can further define edges 139 and broadsides 141 that are configured and oriented as described above with respect to the edges 124a and 124b of the electrical contacts 124 of the fourth electrical connector 36.

In accordance with one embodiment the third electrical connector 34 is shaped differently than the fourth electrical connector 36 but physically mates with the fourth electrical connector 36. The connector housings 122 and 132 can be configured such that the connector housing 132 of the third electrical connector 34 receives the connector housing 122 of the fourth electrical connector 36. Alternatively, the connector housing 122 of the fourth electrical connector 36 can be configured to receive the connector housing 132 of the third electrical connector 34.

The mounting portion 43 and the mating portion 44 of the fourth electrical connector 36 are oriented substantially perpendicular to each other, such that the fourth electrical connector 36 can be referred to as a right-angle connector. Alternatively, the fourth electrical connector 36 can be configured as a vertical or mezzanine connector, whereby the mounting portion 43 and the mounting portion 44 are oriented substantially parallel to each other. The mounting portion 102 and the mating portion 104 of the third electrical connector 34 are illustrated as oriented substantially parallel to each other. Accordingly, the third electrical connector 34 can be referred to as vertical or mezzanine connectors. Alternatively, the third electrical connector 34 can be configured as right-angle electrical connectors, whereby the mounting portion 102 and the mating portion 104 are oriented substantially perpendicular to each other. Furthermore, because the electrical contacts 134 receive the electrical contacts 124, the fourth electrical connector 36 can be referred to as a receptacle connector and the third electrical connector 34 can be referred to as a header connector. Alternatively, the third electrical connector 34 can be configured as a receptacle connector and the fourth electrical connector 36 can be configured as a header connector, whereby the electrical contacts 134 receive the electrical contacts 124.

Referring now to FIG. 8, the auxiliary electrical connector 42 can be constructed generally as described in U.S. Pat. No. 7,677,900, the disclosure of which is hereby incorporated by reference as if set forth in its entirety herein. It should be appreciated, however, that the third and fourth electrical connectors 34 and 36 can be constructed in accordance with any suitable alternative embodiment as desired.

In accordance with the illustrated embodiment, each of the auxiliary electrical connectors 42 can be configured as a memory connector having an insulating or dielectric connector housing 150 can be longitudinally elongate, and supports a plurality of electrical contacts 152 that can be configured as receptacle contacts configured to receive an edge 27 of a respective one of the auxiliary substrates 25. While one of the auxiliary electrical connectors 42 is illustrated as mounted onto the first surface 24a, it should be appreciated that the auxiliary connectors 42 can be mounted onto the second surface 24b of the second substrate 24 at a location aligned with the auxiliary connectors 42 that are mounted onto the first surface 24a.

The electrical contacts 152 can include a plurality of signal contacts and a plurality of ground contacts disposed adjacent select ones of the signal contacts. For instance, the ground contacts can be disposed adjacent differential signal pairs of the electrical contacts 152. The auxiliary electrical connector 42 can define a mounting portion 146 that is configured to be mounted onto either of the first and second surface 24a or 24b of the second substrate 24 so as to be placed in electrical communication with the electrical traces of the second substrate 24, and an opposed mating portion 148 that is oriented substantially perpendicular to the mounting portion 43 and configured to mate with the auxiliary substrate 25. The electrical contacts 152 define respective substrate mount ends 154 that are configured to be electrically connected to the electrical traces of the second substrate 24 and opposed respective mating ends 156 that are configured to be electrically connected to the auxiliary substrate 25. Accordingly, the auxiliary electrical connectors 42 can each be said to be both electrically and physically connected to the second and third substrates 24 and 25. The auxiliary electrical connectors 42 can include at least one latch 158 such as a pair of longitudinally opposed latches 158 configured to releasably secure the auxiliary substrate 25 to the auxiliary electrical connector 42.

It should be appreciated that the electrical connector system 20 has been illustrated and described in accordance with one embodiment, and that numerous alternative embodiments are envisioned that permit the second substrate 24 to be brought into and out of electrical communication with the first substrate 22 along a direction parallel to the first substrate 22 in the manner described herein. For instance, both of the first and fourth electrical connectors 30 and 36 can be configured as right-angle connectors that are configured to mate directly with each other instead of through the transition assembly 26. Accordingly, it can be said that the electrical connector system 20 includes an electrical connector attached to the first substrate 22, and electrical connector attached to the second substrate 24 that is configured to be placed in electrical communication with the electrical connector of the first substrate 22 so as to place the first and second substrates 22 and 24 in electrical communication with each other.

The foregoing description is provided for the purpose of explanation and is not to be construed as limiting the invention. While various embodiments have been described with reference to preferred embodiments or preferred methods, it is understood that the words which have been used herein are words of description and illustration, rather than words of limitation. Furthermore, although the embodiments have been described herein with reference to particular structure, methods, and embodiments, the invention is not intended to be limited to the particulars disclosed herein. Those skilled in the relevant art, having the benefit of the teachings of this specification, may effect numerous modifications to the invention as described herein, and changes may be made without departing from the spirit and scope of this disclosure, for instance as defined by the appended claims.

What is claimed is:

1. An electrical connector assembly comprising:
a first electrical connector including a connector housing and a plurality of electrical contacts;
a second electrical connector including a connector housing and a plurality of electrical contacts, wherein the second electrical connector is shaped differently than the first connector but physically mates with the first connector such that the electrical contacts of the second electrical connector are in electrical communication with the electrical contacts of the first electrical connector; and
a third electrical connector that is shaped differently than at least one of the first electrical connector and the second electrical connector and is electrically connected to the second electrical connector by a flex cable.

2. The electrical connector assembly recited in claim 1, wherein the first electrical connector is configured to be mounted to a first substrate, the electrical connector assembly further comprising a fourth electrical connector configured to be mounted to a second substrate and mated with the third electrical connector so as to place the first and second substrates in electrical communication with each other.

3. The electrical connector assembly as recited in claim 2, further comprising a transition assembly comprising a transition housing that supports the second and third electrical connectors.

4. The electrical connector assembly as recited in claim 3, wherein the transition assembly comprises a first guidance module configured to engage a complementary second guidance module associated with the fourth electrical connector so as to align the third and fourth electrical connectors before the third and fourth electrical connectors are mated.

5. The electrical connector assembly as recited in claim 2, further comprising an auxiliary electrical connector configured to electrically connect an auxiliary electrical connector to the second substrate 24.

6. The electrical connector assembly as recited in claim 5, wherein the first substrate comprises a motherboard, and the auxiliary substrate comprises a memory card.

7. An electrical connector assembly comprising:
a first electrical connector including a connector housing and a first plurality of electrical contacts supported by the connector housing, each of the electrical contacts defining an edge, a broadside that is longer than the edge, and a substrate mount end that is configured to be mounted to a first substrate;
a second electrical connector electrically connected to the first electrical connector, the second electrical connector comprising a connector housing that and a second plurality of electrical contacts that each defines an edge, a broadside that is longer than the edge, and a substrate mount end that is configured to be mounted to a second substrate,
wherein (i) the first broadside of one of the first electrical contacts is oriented substantially perpendicular to the second broadside of one of the second electrical contacts, and (ii) the second electrical connector does not extend beyond an outer perimeter of the first substrate.

8. The electrical connector assembly as recited in claim 7, further comprising a transition assembly configured to place the first and second electrical connectors in electrical communication.

9. The electrical connector assembly as recited in claim 8, wherein the transition assembly comprises a transition housing and a pair of electrical connectors supported by the transition housing and configured to be electrically connected to the first and second electrical connectors so as to place the first and second electrical connectors in electrical communication with each other.

10. The electrical connector assembly as recited in claim 9, wherein the transition assembly further comprises a flex circuit configured to place the pair of electrical connectors in electrical communication with each other.

11. The electrical connector assembly as recited in claim 10, further comprising an auxiliary electrical connector configured to be mounted to the second substrate and further configured to be placed in electrical communication with a third substrate.

12. An electrical connector assembly comprising:
a first electrical connector including a connector housing and a first plurality of electrical contacts that define respective edges, a broadsides that are longer than the edges, and a mount end that is configured to be physically and electrically connected to a first substrate that lies in a first plane; and
a second electrical connector including a connector housing and a second plurality of electrical contacts that define respective edges, a broadsides that are longer than the edges, and a mount end that is configured to be physically and electrically connected to a second substrate that lies in a second plane that is different than the first plane,
wherein (i) the edges of the electrical contacts of the second electrical connector are oriented to face the second plane when the mount end is physically and electrically connected to the second substrate, (ii) the broadsides of the second plurality of electrical contacts are oriented substantially perpendicular to the broadsides of the first plurality of electrical connectors, and the edges of the second plurality of electrical contacts are oriented substantially perpendicular to the edges of the first plurality of electrical connectors, and (iii) the first electrical connector does not extend beyond an edge of the first substrate.

13. The electrical connector assembly as recited in claim 12, further comprising a transition assembly configured to electrically connect the first and second electrical connectors.

14. The electrical connector assembly as recited in claim 13, further comprising an auxiliary electrical connector configured to be mounted to the second substrate and electrically connect to an auxiliary substrate so as to place the auxiliary substrate in electrical communication with the first substrate.

15. A method to replace a daughtercard in an electrical connector assembly, the method comprising the steps of:
providing or teaching the use of a first electrical connector that is capable of being attached to a first substrate oriented in a first plane such that the first connector does not overhang an edge of the first substrate;
providing or teaching the use of a second electrical connector that is capable of being placed in electrical communication with the first electrical connector and is capable of being attached to a second substrate that oriented in a second plane substantially perpendicular to the first plane; and
permitting or teaching movement of the second substrate in a direction parallel to the first substrate when the first electrical connector is placed into or out of electrical communication with the second electrical connector.
